(19) United States
(12) Patent Application Publication
(10) Pub. No.: US 2017/0326461 A1
(43) Pub. Date: Nov. 16, 2017

(54) Bracket Fantasy Sports with Community League

(71) Applicant: MB Fantasy Football League, Inc., Atlanta, GA (US)

(72) Inventor: Charles Taylor, Stockbridge, GA (US)

(21) Appl. No.: 15/594,797

(22) Filed: May 15, 2017

Related U.S. Application Data
(60) Provisional application No. 62/336,716, filed on May 15, 2016.

(51) Int. Cl. A63F 13/828; A63F 13/44

(52) U.S. Cl. CPC A63F 13/828; A63F 13/44; A63F 2300/8052

(57) ABSTRACT

Sport contestants submit names for their fantasy sports teams and a lineup with names associated with field positions. For each interval of the season all teams are allocated to one of two leagues; only undefeated teams are allocated to a bracket league and all remaining teams are allocated to a community league. Teams in the bracket league are paired for one-on-one competitions for that interval. After each interval each team is assigned a score in dependence on performance of professional players that match the names in the lineup. For each bracket league team pair there is a winner and a loser; the loser goes to the community league and the winner is retained in the bracket league for the next interval. For at least the final interval the bracket league winner is awarded a monetary prize, and the community league winner is also awarded a lesser prize.

### PRIORITY CLAIM

This application claims priority to provisional U.S. patent application Ser. No. 62/336,716 filed on May 15, 2016, the contents of which are hereby incorporated by reference.

### TECHNOLOGICAL FIELD

The described invention relates to online fantasy sports such as fantasy (American) football in which contestants select actual professional players of the sport to populate their respective virtual teams and where the performance of the virtual teams against one another within the fantasy sports contests depends upon the selected players' performance while playing their sport in real life.

### BACKGROUND

Online fantasy sports are known in the art. In general the underlying sport is a team sport for which there are actual teams pitted against one another in live on-field play. Fantasy sports contestants operate from the position of a team manager and populate their fantasy team by ‘drafting’ virtual renditions of the professional players that currently play on the actual teams that compete in the underlying team sport. Performance of the fantasy team is directly related to the on-field actual performance of the actual players who are ‘on’ that fantasy team and selected for play by the fantasy sports contestant/fantasy team manager. For example, if actual running back player AB scores a 6-point touchdown in live on-field play of American football in a current week, any fantasy sports team that drafted a virtual rendition of player AB onto that team and selected player AB for its starting lineup to play for the current week would receive a certain number of points to reflect that touchdown that the actual player AB scored in live on-field play. These basics closely follow the earliest fantasy sports contests which date to about 1962 and were restricted to in-person fantasy sports leagues.

Different from those early in-person fantasy sports leagues, online fantasy sports leagues allow different fantasy team managers to select the same player for their respective fantasy teams and further have a more complex scoring system such as awarding a prescribed number of points for every X passing or rushing yards an actual player accumulates during on-field play in the current contest period. These factors enable a very large increase in the number of different fantasy teams any given league can handle. Since every actual player can be drafted on multiple teams the number of fantasy teams that may compete in a fantasy league is no longer limited to the number of teams that compete in live on-field play. More complex scoring rules to account for player performance that does not necessarily result in points in the live on-field sports contests mean the fantasy play of these multiple fantasy teams can be more precisely distinguished from one another which statistically limits the number of tie scores there may be in the fantasy team play. The end result is that the largest online fantasy sports leagues have set their play such that fantasy teams win by scoring the most points as compared to all other fantasy teams in the league. In this regard winning in an online fantasy sports league is akin to winning a golf tournament in that the best score against all other players wins. But this is a radical departure from how winners are chosen among the actual teams in the live on-field play.

Embodiments of these teachings retain some of the advantages that online fantasy sports offer over in-person fantasy sports while remaining more true to how winners are chosen in the live on-field play in which the actual teams engage. Because online fantasy sports has become a major business this is not a small change in practice; there are a wide variety of supporting businesses to aid in fantasy team drafting which utilize statistical and/or heuristic analysis, and sometimes even artificial intelligence, in order to increase one's odds of winning. Changing how winning is defined radically alters how one engages in any competition and fantasy sports is no exception.

### SUMMARY

According to a first aspect of these teachings there is a method comprising: prior to a start of a multi-interval season for a sport, receiving from each of a plurality of contestants a fantasy sports team comprising names of professional players of the sport where the names are associated with field positions; and also prior to the start of at least an initial interval of the season, receiving from respective ones of the contestants a lineup of their respective fantasy sports team in which each name of the respective lineup is associated with a field position. Further in the method, prior to the start of each interval of the season: a) allocating to a bracket league only those fantasy sports teams that are currently undefeated for the season; b) allocating to a community league all fantasy sports teams that are not in the bracket league; and c) selecting pairs of fantasy sports teams allocated to the bracket league to compete against one another during the respective interval. Following each of the intervals of the season the method proceeds with d) assigning to each fantasy sports team a score for the respective interval in dependence on performance of the professional players of the sport during the respective interval that match the names of the respective fantasy sports team lineup; e) based on the respective fantasy sports team scores for the respective interval, determining for each pair of fantasy sports teams a winner and a loser; and f) retaining each winner in the bracket league for the next subsequent interval and moving each loser to the community league for the next subsequent interval. The method selects winners at least as follows. The fantasy sports team that is determined to be the winner following a final interval of the season is selected as a winner of the bracket league and thee is awarded to the contestant associated with the winner of the bracket league a bracket league winner monetary prize. Additionally in the method, one of the fantasy sports teams that did not compete in the bracket league during the final interval of the season is selected as a winner of the community league and there is awarded to the contestant associated with the winner of the community league a community league winner monetary prize that is less than the bracket league winner monetary prize.

According to a second aspect of these teachings there is one or more servers comprising at least one processor and at least one memory storing a program of executable computer instructions. This one or more processor(s) is configured with the at least one memory and the program of executable instructions to cause the one or more servers to perform actions comprising: prior to a start of a multi-interval season for a sport, receive from each of a plurality of contestants a fantasy sports team comprising names of professional players of the sport associated with field positions; and prior to the start of at least an initial interval of the season, receive from respective ones of the contestants a lineup of their respective fantasy sports team in which each name of the respective lineup is associated with a field position. The actions further include, prior to the start of each interval of the season; a) allocate to a bracket league only those fantasy sports teams that are currently undefeated for the season; b) allocate to a community league all fantasy sports teams that are not in the bracket league; and c) select pairs of fantasy sports teams allocated to the bracket league to compete against one another during the respective interval. Further actions following each of the intervals of the season include: d) assign to each fantasy sports team a score for the respective interval in dependence on performance of the professional players of the sport during the respective interval that match the names of the respective fantasy sports team lineup; e) based on the respective fantasy sports team scores for the respective interval, determine for each pair of fantasy sports teams a winner and a loser; and f) retain each winner in the bracket league for the next subsequent interval and move each loser to the community league for the next subsequent interval. Following all this the actions include select the fantasy sports team that is determined to be the winner following a final interval of the season as a winner of the bracket league and awarding to the contestant associated with the winner of the bracket league a bracket league winner monetary prize; and select one of the fantasy sports teams that did not compete in the bracket league during the final interval of the season as a winner of the community league and awarding to the contestant associated with the winner of the community league a community league winner monetary prize that is less than the bracket league winner monetary prize.

According to a third aspect of these teachings there is one or more computer readable memories storing a program of computer instructions that when executed by one or more processors of one or more electronic devices causes the electronic devices to perform certain actions. In this third aspect the actions comprise: prior to a start of a multi-interval season for a sport, receive from each of a plurality of contestants a fantasy sports team comprising names of professional players of the sport associated with field positions; and prior to the start of at least an initial interval of the season, receive from respective ones of the contestants a lineup of their respective fantasy sports team in which each name of the respective lineup is associated with a field position. Among further actions which are performed prior to the start of each interval of the season are a) allocate to a bracket league only those fantasy sports teams that are currently undefeated for the season; b) allocate to a community league all fantasy sports teams that are not in the bracket league; and c) select pairs of fantasy sports teams allocated to the bracket league to compete against one another during the respective interval. Among further actions performed following each of the intervals of the season are: d) assign to each fantasy sports team a score for the respective interval in dependence on performance of the professional players of the sport during the respective interval that match the names of the respective fantasy sports team lineup; e) based on the respective fantasy sports team scores for the respective interval, determine for each pair of fantasy sports teams a winner and a loser; and f) retain each winner in the bracket league for the next subsequent interval and move each loser to the community league for the next subsequent interval. Further actions following these are to select the fantasy sports team that is determined to be the winner following a final interval of the season as a winner of the bracket league and awarding to the contestant associated with the winner of the bracket league a bracket league winner monetary prize; and to select one of the fantasy sports teams that did not compete in the bracket league during the final interval of the season as a winner of the community league and awarding to the contestant associated with the winner of the community league a community league winner monetary prize that is less than the bracket league winner monetary prize.

These and other aspects of the invention are detailed further below with particularity.

### BRIEF DESCRIPTION OF THE DRAWINGS

FIG. 1 is a schematic diagram conceptually illustrating one bracket of a bracket league of fantasy American football that handles a maximum of 2ⁿ=65,536 fantasy teams in one-on-one play across n=16 weekly intervals of play and a community league in which those defeated in bracket play are automatically entered, according to an example embodiment of these teachings.

FIG. 2 is a process flow diagram illustrating certain aspects of these teachings from the perspective of a central server or group of cloud-based servers that implement the fantasy sports leagues described herein.

FIG. 3 is a high level schematic block diagram showing an environment in which these teachings may be practiced and certain components of a server suitable for practicing these teachings.

### DETAILED DESCRIPTION

The description below uses American football as an example sport for which the fantasy version is detailed with respect to embodiments of these teachings. American football is a non-limiting example, and these teachings can be implemented for any team sport in which the season is divisible into intervals such as American football's season is divided into weekly intervals. Unless otherwise specified herein, the term football refers to American football.

In general for fantasy sports the performance of the individual fantasy sports teams for a given interval (for example, a week of the football season) reflect the on-field performance of actual professional players of the sport, during the current interval, that the fantasy team ‘manager’ selects for his/her fantasy team. In this regard each fantasy team is populated with the names of actual players of the sport. There is a pre-defined scoring regimen by which such performance translates to points for the fantasy football team. An example fantasy football scoring regimen for offense and for defense is presented at respective Tables 1 and 2 below.

TABLE 1
Fantasy Team Scoring based
on on-field offensive player performance.

| | On-field player performance | Fantasy team points |
|---|---|---|
| Passing | Touchdown via pass thrown | 4 |
| | Every 25 passing yards thrown | 1 |
| | 2-point conversion thrown | 2 |
| | Interception thrown | −2 |
| Rushing | Touchdown rushing | 6 |
| | Every 10 rushing yards | 1 |
| | 2-point conversion rushing | 2 |
| Receiving | Touchdown via pass received | 6 |
| | Every 10 pass reception yards | 1 |
| | 2-point conversion pass received | 2 |
| Miscellaneous | Kickoff return touchdown | 6 |
| Offense | Punt return touchdown | 6 |
| | Fumble recovered for touchdown | 6 |
| | Fumble turnover | −2 |
| Kicking | Field goal made (50+ yards) | 5 |
| | Field goal made (40-49 yards) | 4 |
| | Field goal made (0-39 yards) | 3 |
| | Point after touchdown made | 1 |
| | Field goal missed (any distance) | −1 |

TABLE 2
Fantasy Team Scoring based on
on-field defensive player performance.

| | On-field player performance | Fantasy team points |
|---|---|---|
| Defensive | Kickoff returned for touchdown | 6 |
| Touchdowns | Punt returned for touchdown | 6 |
| | Interception returned for touchdown | 6 |
| | Fumble returned for touchdown | 6 |
| Miscellaneous | Blocked punt or field goal returned | 6 |
| Defense | for touchdown | |
| | Interception | 2 |
| | Fumble recovered | 2 |
| | Blocked punt, point after | 2 |
| | touchdown or field goal | |
| | Safety | 2 |
| | Sack | 1 |

For example, if Fantasy Team Q names quarterback Joe Smith to play in week 4 and during week 4 the actual Joe Smith throws for a total of 287 yards including 2 touchdown passes and one interception, Joe Smith's on-field performance will add a total of 17 points to Fantasy Team Q's score for week 4 (11 points for passing yards thrown, 8 points for touchdowns thrown and -2 points for one interception thrown). Fantasy Team Q's total score for week 4 may be computed by adding the fantasy point contribution from all players named to team Q's starting lineup for week 4 corresponding to those respective players' on-filed performance during week 4.

Conventional online fantasy football regimens generally do not allow for team scoring contributions from individual defensive players. Embodiments of these teachings can include defensive fantasy sports points from individual defensive team players' on-filed performance in the weekly team totals, or may arrive at the weekly team totals using a conventional ‘team defense’ approach in which the entire defensive line of the fantasy team is chosen by the fantasy team ‘manager’ as one on-field team's defensive line, and only team defensive fantasy points are included with the fantasy team total score for the week. The defensive fantasy points of the example Table 2 can be used for individual defensive players' performances in one embodiment, or for an on-field team defense performance in another embodiment.

To avoid confusion between the actual on-field players of the sport and their counterparts on a given fantasy team, the on-field players are referred to herein as players or professional players of the sport, while the members of the fantasy team will be referred to as names of the players. Each fantasy sports team will be populated with names of players selected by the fantasy team manager. Each name is associated with one or a limited few positions on the team, so for example one name may be associated with the position of wide receiver while another is associated with quarterback and still another is associated with running back. There may be multiple names associated with one position on a fantasy team, for example three quarterbacks and two running backs, in order for the fantasy team manager to account for potential injuries during the season of on-field players and to allow the fantasy team manager flexibility when setting its lineup. The fantasy team manager is a contestant but the term manager is used herein to associate with a unique fantasy team since any given natural-person contestant may create and enter into the fantasy league multiple online fantasy teams.

In some embodiments there is a maximum number of names the fantasy team manager may submit (for example, 45 names maximum) to populate a fantasy team, and at least prior to the start of the season (prior to the initial week of play) the manager submits a lineup of those names that will ‘play’ for the fantasy team. Names on the fantasy team roster that are not in the lineup are ‘benched’ and do not contribute to the fantasy team's score while they are benched; only names in the lineup contribute to the fantasy team's score. Where the manager can select names of individual defensive team players, in one embodiment the lineup can include names for one defensive lineman (tackle or end) position, one flex-position defensive lineman/linebacker position, one linebacker position, and 2 flex-position cornerback/safety positions. In some embodiments there is one lineup that persists for the entire season (with the exception that names may be substituted if an on-field player named in a fantasy team's lineup becomes injured or otherwise becomes unqualified or is unable to perform in on-field play for the coming week), and in another the fantasy team manager has the option of setting a new lineup for each week and if no new lineup is set the previous week's lineup is automatically the lineup for the coming week.

As will be detailed below, for bracket league play the fantasy teams are paired against one another in one-on-one competitions for each week, each fantasy team that is in the bracket league engaging in exactly one such one-on-one competition per week. There may be occasional exceptions to this pairing whereby a fantasy team in bracket league play gets a ‘bye’ week in which they do not compete during that week, for example if there are an odd-number of fantasy teams at the start of week 1. Teams in the bracket league that get a ‘bye’ week automatically advance within the bracket league for the next subsequent week. In an embodiment the fantasy team selected to get a ‘bye’ week is selected at random.

For the case in which the fantasy team managers can change their respective team's lineup week to week, in an embodiment at least the managers of fantasy teams in the bracket league are enabled to view the most recently played lineup of the fantasy team opponent for the upcoming week, and preferably these managers are enabled to view all lineups used at any time in the bracket league for the current season by any fantasy team. This makes additional information available to the fantasy team managers on their upcoming opponent so each fantasy team manager in bracket league play can more particularly tailor their lineup to win the upcoming one-on-one bracket league contest. Whether there is only one lineup allowed for the season (with name substitutions allowed to account for injuries of any on-field players) or week-to-week changes to lineups are allowed, there is a deadline prior to the start of any on-field play of the actual teams for the week by which the manager must submit the lineup. So for example assuming football is scheduled for on-field play between Thursday evening and the following Monday evening for any given week of the season, the lineup submission deadline for any given week may be midnight on the Wednesday prior to the Thursday which begins that given week, or it may be 3 pm Atlanta time on the Thursday of that given week.

If a manager does not submit a lineup by the prescribed deadline, the fantasy team's default lineup is entered automatically. The default lineup may be selected by managers when ‘drafting’ their fantasy team. As with conventional fantasy football, such ‘drafting’ of fantasy teams may be subject to a salary cap per fantasy team.

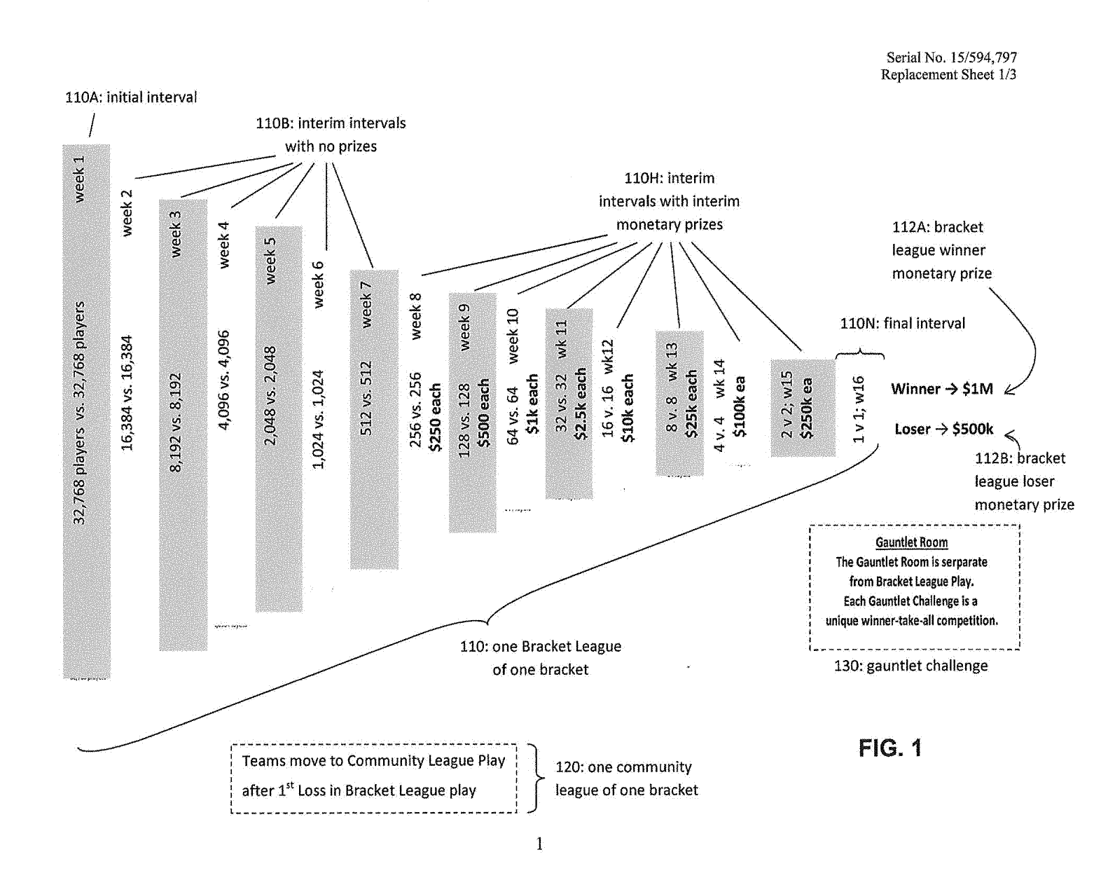

Now having defined the fantasy teams with rosters of names and lineups, as well as how the fantasy team scores are determined in dependence on the on-field performance of the professional players of the sport corresponding to the names of the lineup, refer to FIG. 1 for an explanation of the bracket league 110 play and the community league 120 play. In embodiments of these teachings, throughout the season only those fantasy teams that are undefeated will compete in bracket league 110 play, and upon defeat in the bracket league 110 any given fantasy team is automatically moved to community league 120 play for the remainder of the season. Team rosters and scoring remain the same for bracket league 110 and community league 120 play, and if the fantasy team manager is able to change his/her fantasy team's lineup in bracket league 110 play generally he/she will be able to change it in the community league 120 play. However, in community league 120 play there is no designated opponent. Instead the highest score per week among all the fantasy teams in the community league 120 determines the community league winner or winners for that week.

As with the above examples FIG. 1 is a non-limiting example for fantasy football. Like on-field football there are 16 weeks in the fantasy sport season, shown chronologically as:
an initial interval 110A (week 1);
followed by a few interim intervals with no prizes 110B (weeks 2 through 7);
followed by several interim intervals with prizes 110H (weeks 8 through 15); and
followed by a final interval 110N (week 16).

Because the competitions in the bracket league 110 are each exactly one fantasy team versus exactly one fantasy team, the bracket league can accommodate no more than 2ⁿ fantasy teams, and so for the case of n=16 the maximum number of fantasy teams is 2¹⁶=65,536. If more than this maximum number of fantasy team managers sign up a fantasy team prior to the start of the season for the on-field sport (or prior to the fantasy team submission deadline which may be somewhat earlier in time), another (second) bracket is created and the excess fantasy teams over 65,536 go into the bracket league of this newly created other bracket. Once this other/second bracket is filled any excess fantasy teams over 2*65,536 go into the bracket league of a further (third) bracket, and so forth until all fantasy team managers and teams that enter are assigned to a bracket league of a specific bracket out of a total of one or more brackets. FIG. 1 illustrates bracket league play for one bracket only, but other second, third, etc. brackets operate identically in parallel.

In an embodiment the final week winners of bracket league play for different brackets may be given an option to play one-on-one against each other for an additional entry fee and the winner of each inter-bracket competition wins a monetary prize. This is not specifically shown in FIG. 1 but the winner from the final interval/week 110N at FIG. 1 will compete against its counterpart winner of a parallel bracket, identical in kind but operating with different fantasy teams, that runs in the same season. If there are a total of three or more brackets the winner of the inter-bracket competition also advances to play other inter-bracket winning fantasy teams, along with any fantasy team that gets a ‘bye’ in the previous round of inter-bracket competition, until there is one ultimate fantasy team winner for the season. For the case of a ‘bye’ in the inter-bracket competitions, the fantasy team selected for this ‘bye’ is selected based on merit, for example highest total fantasy points in the season, highest average margin of victory throughout the season, and so forth.

Assuming the bracket league 110 of FIG. 1 is filled, there are 65,536 unique fantasy teams. In truth it may be not all teams are unique among their roster and/or lineup as even a same manager may duplicate his/her fantasy team, roster and lineup if not prohibited by the implementing software or rules. Such a rarity makes no difference to the conduct of the fantasy play and so it can be assumed that all fantasy teams are unique without loss of this description's practicality or clarity. During play in week 1 (initial interval 110A) each of the 65,536 teams are undefeated and so every one of them are in the bracket league 110 for week 1. FIG. 1 illustrates 32,768 teams at the top of week 1 and 36,768 teams at the bottom of week 1. Since team competitions in the bracket league 110 are one-on-one, there are 36,768 one-on-one competitions in week 1. The winner of each of these competitions is the fantasy team that outscores its fantasy team opponent. So for example if during week 1 fantasy team #1 competes against fantasy team #2 and wins by a score of 41 to 37, fantasy team #1 is the winner of that bracket league 110 competition during week 1 and would remain in the bracket league 110 for week 2 despite that every other fantasy team in week #1 may score more than 41 fantasy points. In this example fantasy team #2 would move automatically to the community league 120 beginning in week #2 since it is no longer undefeated. Assuming no tie scores and that no fantasy team that has a ‘bye’ in week 1 (110A), mathematically 36,768 fantasy teams will be winners for week 1 in the bracket league 110 and will thus remain in the bracket league 110 for the start of week 2 while the other 36,768 fantasy teams will be losers for week 1 in the bracket league 110 and will thus automatically move to the community league 120 for the start of week 2. Once a fantasy team is in the community league 120 it cannot return to the bracket league 110 for the remainder of the season.

In bracket league 110 play no pair of competing teams can end with a tie score so there is a rule or set of rules to settle any tied fantasy scores. In one example the rule is that in the event of a tie the fantasy team with the higher number of points in the final period of play (final quarter if the sport is football) is declared the winner, and if this still does not resolve the tie the fantasy team with the higher number of points in the final two periods of play is declared the winner, and so forth.

This continues throughout all the other interim weeks 110B, 110H. In the FIG. 1 example there are 36,768 competitions and an equal number of fantasy team winners in the bracket league 110 for week 2; there are 18,384 competitions and an equal number of fantasy team winners in the bracket league 110 for week 3; and so forth where the number of competitions and winners in the bracket league 110 halves in each subsequent week. For the initial week 110A and some number of interim weeks 110B sequentially following the initial week 110A, no monetary prizes are awarded to the winners of the bracket league 110 competitions.

Following these there are several consecutive interim intervals/weeks 110H preceding the final interval/week 110N in which prizes are awarded to the manager of each fantasy team that prevails in its bracket league 110 competition, and as FIG. 1 illustrates the amount of these monetary prizes increases progressively as the respective week 110H is nearer in time to the final interval/week 110N. The manager of the prevailing fantasy team in the final week 110N bracket league 110 competition is awarded the largest prize of FIG. 1, termed a bracket league winner monetary prize 112A. The manager of the non-prevailing fantasy team in the final week 110N of bracket league 110 competition is awarded a smaller prize which FIG. 1 terms a bracket league loser monetary prize 112B; this is the only fantasy team that is a losing team which is awarded a monetary prize. Monetary awards shown by example at FIG. 1 are then as follows.

TABLE 3
Bracket League monetary awards.

| Week | # of winning fantasy teams | Per-team monetary prize |
|---|---|---|
| 8 | 256 | $250 |
| 9 | 128 | $500 |
| 10 | 64 | $1,000 |
| 11 | 32 | $2,500 |
| 12 | 16 | $10,000 |
| 13 | 8 | $25,000 |
| 14 | 4 | $100,000 |
| 15 | 2 | $250,000 |
| 16 | 1 | $1,000,000 |

Monetary prizes in the community league 120 are less generous but may operate on a similarly progressively-increasing basis for each week in which a monetary prize is awarded. The weeks in which monetary prizes are awarded for the community league 120 may or may not match those weeks in which monetary prizes are awarded in the bracket league 110, but for simplicity of this example assume that they are. In this non-limiting example there are a total of 100 fantasy teams that are designated winners in the community league 120 for each week in which community league 120 monetary prizes are awarded. Tie fantasy scores are resolved as above so there are no tie scores in the community league 120 when a monetary prize is at stake. In this example of the monetary prizes for the community league 120 are paid out only in weeks 8 through 16, and identically in each of those weeks (though obviously different fantasy teams may be winners in different weeks). After resolving any fantasy scores that are tied for the week so there are no ties, fantasy teams in the community league 120 are rank-ordered according to their scores for the given week and the top 100 fantasy teams in this ranking are awarded as shown at Table 4 below.

TABLE 4
Community League monetary awards,
each week in which awards are given.

| # of winning fantasy teams | Per-team monetary prize |
|---|---|
| Top scoring/top ranked fantasy team | $25,0000 |
| Next 2-5 scoring/ranked teams | $10,000 each |
| Next 6-10 scoring/ranked teams | $5,000 each |
| Next 11-25 scoring/ranked teams | $2,500 each |
| Next 26-50 scoring/ranked teams | $1,000 each |
| Next 51-100 scoring/ranked teams | $500 each |

In some embodiments there is an optional ‘gauntlet room’ 130 which is a venue in which any fantasy team may engage in one-on-one competition with another fantasy team. This is strictly voluntary from week to week and any fantasy team, whether in the bracket league 110 or the community league 120, can play in the gauntlet room 130 one or multiple times in any given week, all in parallel with that same team playing in the bracket or community league. In one embodiment the managers may be able to set a different lineup for their gauntlet room play, or for each gauntlet room competition, different from their same-week lineup in the bracket league or the community league. Essentially managers volunteer their team for the gauntlet room 130, the implementing software pairs the gauntlet room teams or the managers mutually agree to a one-on-one competition between their respective teams/lineups, and they each pay a separate gauntlet room entry fee for each gauntlet room competition in which their fantasy team engages. There may be a fixed minimum fee to which managers can add to when both competing fantasy team managers agree, and this addition may be in the manner of onscreen raising and calling bids to increase the fee from both competing fantasy team managers. The manager of the winning fantasy team of a gauntlet room competition gets his/her fee back plus the fee paid by the competing fantasy team's manager, less a cut for the gauntlet room administrator such as 5% for example. In this regard the gauntlet room 130 is a winner-take-all proposition for the competing fantasy teams. Gauntlet room 130 participation and results have no effect on winning or not, or any monetary award amount, in the bracket league 110 and in the community league 120.

Unlike other online fantasy sports football regimens, in embodiments of these teachings there are two parallel leagues 110, 120 and a losing fantasy team in the bracket league 110 is not a loser for the season because they are automatically moved to the community league 120 where there are a higher number of opportunities to win, albeit at lower average monetary prize values. Each manager pays a single entry fee for the season and there is no additional fee due to continue fantasy play in the community league 120. Also unlike other online fantasy sports regimens the bracket league 110 offers one-on-one competitions with progressive payouts for repeat winners once the season has progressed to the interim weeks 110H in which monetary prizes are awarded. In the example of FIG. 1 the winner of the bracket league monetary prize 112A, which is the largest monetary prize available, needs only to defeat 16 other fantasy teams as opposed to other fantasy sports regimens in which each fantasy team competes against all other fantasy teams (for example, 80,000 or more other teams) and the grand prize winner must beat them all. Further unlike other fantasy sports regimens, in these teachings for the bracket league 110 each manager can see what lineups its upcoming opposing team has played in the past and has set for the current week; that information is simply not useful where the competition is against every other fantasy team that enrolled. In this regard the manager of an individual team may submit multiple lineups but can select only one per team per week; to play multiple different lineups the manager would need to register the same team multiple times (that is, enter the same roster of players on differently registered teams) and play the different lineups in the differently-registered teams in a given week.

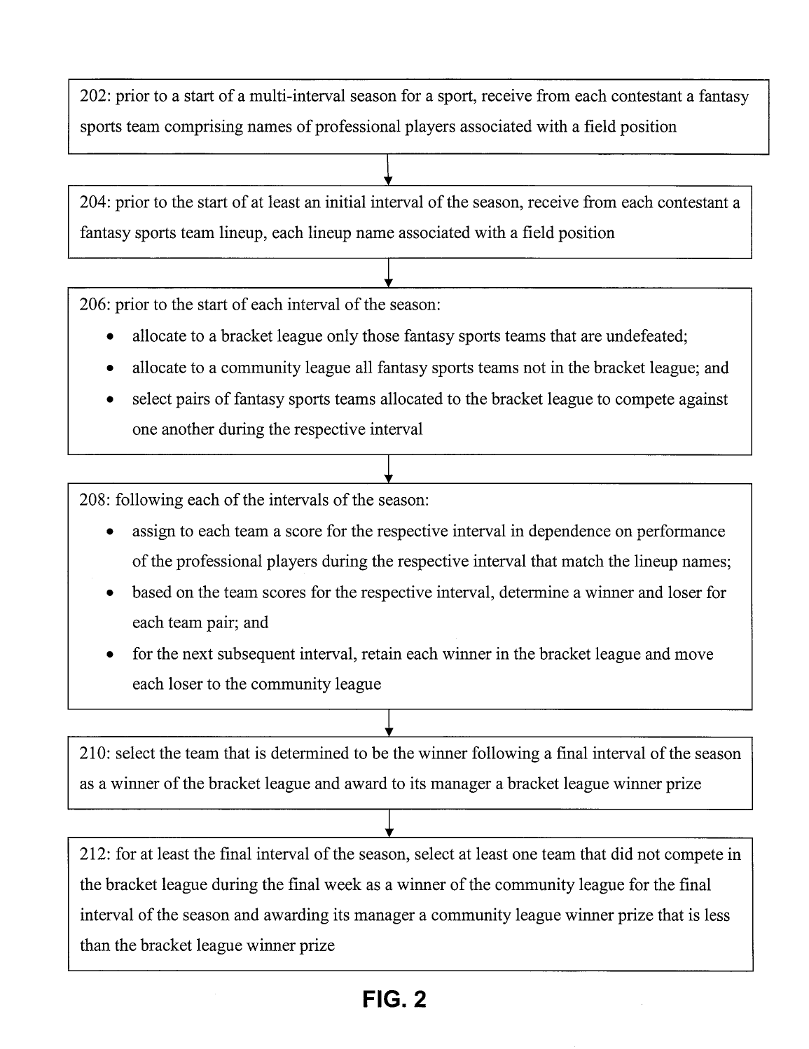

FIG. 2 is a process flow diagram illustrating some aspects of these teachings from the perspective of a central server or group of (Internet) cloud-based servers that implement the fantasy sports leagues as detailed more fully above. Block 202 begins with the team managers selecting their fantasy team rosters; from the perspective of the servers running the implementing software, prior to a start of a multi-interval season for a sport the servers receive from each of a plurality of contestants a fantasy sports team comprising names of professional players of the sport where the names are associated with field positions. At block 204 the team managers submit their respective lineups, which from the servers' perspective, prior to the start of at least an initial interval of the season, those servers receive from respective ones of the contestants a lineup of their respective fantasy sports team in which each name of the respective lineup is associated with a field position. Block 206 sets the various teams in the appropriate league and sets the bracket league competitions in that prior to the start of each interval of the season the servers a) allocate to a bracket league only those fantasy sports teams that are currently undefeated for the season, b) allocate to a community league all fantasy sports teams that are not in the bracket league, and c) select pairs of fantasy sports teams allocated to the bracket league to compete against one another during the respective interval. Following each of the intervals of the season at block 208 the servers d) assign to each fantasy sports team a score for the respective interval in dependence on performance of the professional players of the sport during the respective interval that match the names of the respective fantasy sports team lineup, e) based on the respective fantasy sports team scores for the respective interval they determine for each pair of fantasy sports teams a winner and a loser, and f) they retain each winner in the bracket league for the next subsequent interval and move each loser to the community league for the next subsequent interval. Block 210 finds the bracket league winner for the final week, namely the fantasy sports team that is determined to be the winner following a final interval of the season is selected as a winner of the bracket league and the contestant associated with the winner of the bracket league is awarded a bracket league winner monetary prize. Block 212 finds the community league winner for the final week, namely one of the fantasy sports teams that that did not compete in the bracket league during the final interval of the season as a winner of the community league and the contestant associated with the winner of the community league is awarded a community league winner monetary prize that is less than the bracket league winner monetary prize. With regards to blocks 210 and 212, the awarding of the monetary prize may be implemented by the servers as simply electronically notifying the respective winners that they have won and possibly also the amount of their respective monetary prize; the presentation of the actual prize money need not be done by the servers themselves and preferably is performed through different servers associated with bank-level security for electronic funds transactions.

In the non-limiting examples above the multi-interval season of block 202 consists of the initial interval 110A, the final interval 110N and multiple interim intervals 110B, 110H between the initial and final intervals, and following each of several 110H but less than all consecutive ones of the interim intervals, there was awarded prizes to the managers of the bracket league winning fantasy teams. Utilizing the terminology of FIG. 2, in each of these interim weeks 110H, each of the contestants associated with the respective fantasy sports teams that were determined for each pair of fantasy sports teams to be a winner for the respective interim interval (block 208) there is awarded a bracket league interim monetary prize (see Table 3) that is less than the bracket league winner monetary prize 112A. In the specific Table 3 example above the amount of the interim bracket league monetary prize for the respective several consecutive interim intervals increases progressively as the respective interim interval is nearer in time to the final interval.

Whereas FIG. 1 illustrates only one bracket (bracket including one bracket league and one community league, with possibly also the gauntlet room which may or may not be limited to only those teams in one specific bracket), the process flow of FIG. 2 can be implemented over multiple brackets during a single season. In this case if there are a total of n intervals in the season each bracket would include a maximum of 2ⁿ fantasy sports teams (assume n is an integer at least five). For these multiple brackets the winner of the bracket league and the winner of the community league are selected at blocks 201 and 212 for each of the multiple brackets, and the same bracket league winner monetary prize and the same community league monetary prize are awarded for each of the multiple brackets. Alternatively, different brackets can have different monetary award amounts corresponding to the amount of the contestant's entry fee; the bracket(s) with a $150 entry fee may have a highest prize 112A of $1,000,000 as in FIG. 1 while a parallel bracket(s) in the same season may require a $250 entry fee and pay out a highest prize 112A of $2,000,000.

The above examples had the sport as American football, where each interval of FIG. 2 is a week, and as FIG. 1 illustrates there are at least sixteen weeks in the season and the several (but less than all) consecutive ones of the interim intervals/weeks in which interim monetary prizes are awarded total at least eight consecutive weeks which immediately precede the final week of the season (weeks 8-15 of FIG. 1).

For the example at Table 3 where in certain interim weeks 110H the bracket league winners were awarded a monetary prize, Table 4 is an example of how in certain of the weeks there at least one of the fantasy sports teams selected as a winner of the community league for the respective interim interval/week and to the contestant associated with each of the selected winner or winners of the community league for the respective interim interval/week is awarded a community league interim monetary prize that is less than the community league winner monetary prize. In fact Table 4 provides for multiple of the fantasy sports teams being selected as a winner of the community league for each of these intervals/weeks, and for awarding to those community league multiple fantasy sports team winners monetary prizes that increase progressively with the fantasy sports team scores of those winning teams.

In some embodiments above the manager can select individual defensive players as well as individual offensive players. In that case then the lineup at block 204 of each of the fantasy sports teams includes a first set of names associated with offensive field positions and a second set of names associated with defensive field positions. From this it follows that the scores assigned at block 208 for the respective intervals are assigned in dependence on performance of the professional players of the sport, during the respective interval, that match the first set of names and the second set of names of the respective fantasy sports team lineup.

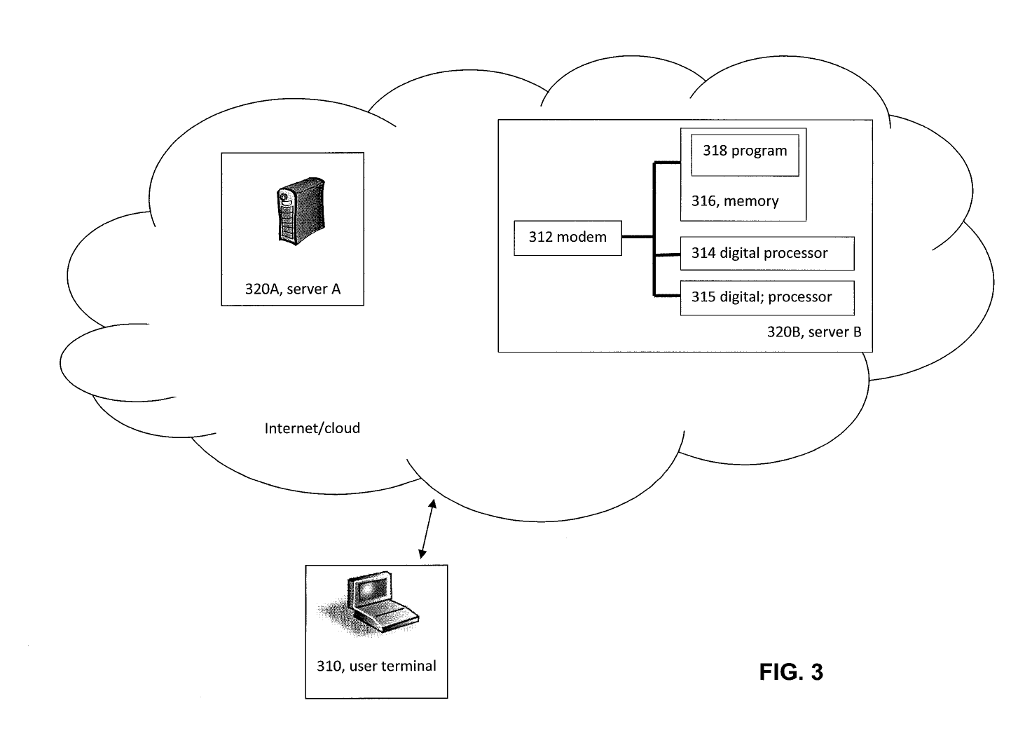

FIG. 3 is a high level diagram illustrating an exemplary environment with cloud-based servers which may embody these teachings, and more specifically a user terminal 310 which may communicate to the cloud (Internet) based servers 320A, 320B the contestant/team manager's selections of roster and lineup and at which the contestant/team manager may receive notifications that he/she is or is not a winner of the various leagues and weeks. While two servers 320A, 320B are shown, these teachings may be embodied on one server or any number of servers in communication with one another over the Internet. The servers are functionally similar in relevant part and as shown the server 320B includes a controller, such as a computer or a data processor (DP) 314 (or multiple ones of them), a computer-readable memory medium embodied as a memory (MEM) 316 (or more generally a non-transitory program storage device) that stores a program of executable computer instructions (PROG) 318, and a suitable communications interface 312 such as a modem to the communications network/Internet that will be used for sharing data stored on the different servers' memories, sharing processing power, and accepting inputs and transmitting outputs. In general terms the server 320B can be considered a machine that reads the MEM/non-transitory program storage device and that executes the computer program code or executable program of instructions stored thereon. While the server 320B of FIG. 3 is shown as having one memory 316, in practice each server 320A, 320B may have multiple discrete memory devices and the relevant algorithm(s) and executable instructions/program code may be stored on one or across several such memories, or even across different memories of different servers.

The program 318 is assumed to include program instructions that, when executed by the associated one or more digital processors 314, enable the server/system 320A/B to operate in accordance with exemplary embodiments of this invention. That is, various exemplary embodiments of this invention may be implemented at least in part by computer software executable by the digital processor 314 of the server/system 320A/B; and/or by hardware, or by a combination of software and hardware (and firmware). Note also that one or more of the servers 320B may also include dedicated processors 315. The electrical interconnects/busses between the components at FIG. 3 are conventional and not separately labelled.

The computer readable memory 316 may be of any memory device type suitable to the local technical environment and may be implemented using any suitable data storage technology, such as semiconductor based memory devices, flash memory, magnetic memory devices and systems, optical memory devices and systems, fixed memory and removable memory. The digital processors 314, 315 may be of any type suitable to the local technical environment, and may include one or more of general purpose computers, special purpose computers, microprocessors, digital signal processors, and processors based on a multicore processor architecture, as non-limiting examples. The modem 312 may be of any type suitable to the local technical environment and may be implemented using any suitable communication technology.

Computer readable memory is non-transitory because propagating mediums such as carrier waves are memoryless. More specific examples (a non-exhaustive list) of the computer readable storage medium/memory would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. A method comprising:
prior to a start of a multi-interval season for a sport, receiving from each of a plurality of contestants a fantasy sports team comprising names of professional players of the sport associated with field positions;
prior to the start of at least an initial interval of the season, receiving from respective ones of the contestants a lineup of their respective fantasy sports team in which each name of the respective lineup is associated with a field position;
prior to the start of each interval of the season:
allocating to a bracket league only those fantasy sports teams that are currently undefeated for the season;
allocating to a community league all fantasy sports teams that are not in the bracket league; and
selecting pairs of fantasy sports teams allocated to the bracket league to compete against one another during the respective interval;
following each of the intervals of the season:
assigning to each fantasy sports team a score for the respective interval in dependence on performance of the professional players of the sport during the respective interval that match the names of the respective fantasy sports team lineup;
based on the respective fantasy sports team scores for the respective interval, determining for each pair of fantasy sports teams a winner and a loser; and
retaining each winner in the bracket league for the next subsequent interval and moving each loser to the community league for the next subsequent interval;
selecting the fantasy sports team that is determined to be the winner following a final interval of the season as a winner of the bracket league and awarding to the contestant associated with the winner of the bracket league a bracket league winner monetary prize; and
selecting one of the fantasy sports teams that did not compete in the bracket league during the final interval of the season as a winner of the community league and awarding to the contestant associated with the winner of the community league a community league winner monetary prize that is less than the bracket league winner monetary prize.

2. The method according to claim 1, wherein the multi-interval season consists of the initial interval, the final interval and multiple interim intervals between the initial and final intervals, the method further comprising:
following each of several but less than all consecutive ones of the interim intervals, awarding to each of the contestants associated with the respective fantasy sports teams that were determined for each pair of fantasy sports teams to be a winner for the respective interim interval a bracket league interim monetary prize that is less than the bracket league winner monetary prize.

3. The method according to claim 2, wherein an amount of the interim bracket league monetary prize for the respective several consecutive interim intervals increases progressively as the respective interim interval is nearer in time to the final interval.

4. The method according to claim 3, wherein:
the method is performed over multiple brackets during the season;
there are a total of n intervals in the season and each bracket includes a maximum of 2ⁿ fantasy sports teams, where n is an integer at least five;
the winner of the bracket league and the winner of the community league are selected for each of the multiple brackets; and
the bracket league winner monetary prize and the community league monetary prize are awarded for each of the multiple brackets.

5. The method according to claim 3, wherein:
the sport is American football, each interval is a week, there are at least sixteen weeks in the season; and
the several but less than all consecutive ones of the interim intervals total at least eight consecutive weeks which immediately precede the final week of the season.

6. The method according to claim 3, further comprising:
following selected ones of the several consecutive interim intervals, selecting at least one of the fantasy sports teams as a winner of the community league for the respective interim interval and awarding to the contestant associated with each of the selected at least one winner of the community league for the respective interim interval a community league interim monetary prize that is less than the community league winner monetary prize.

7. The method according to claim 6, wherein for each selected one of the several consecutive interim intervals:
multiple of the fantasy sports teams are selected as a winner of the community league; and
monetary prizes awarded to the multiple fantasy sports teams selected as a winner of the community league increases progressively with the fantasy sports team scores of the multiple fantasy sports teams.

8. The method according to claim 1, wherein:
the lineup of each of the fantasy sports teams includes a first set of names associated with offensive field positions and a second set of names associated with defensive field positions; and
the scores for the respective intervals are assigned in dependence on performance of the professional players of the sport during the respective interval that match the first set of names and the second set of names of the respective fantasy sports team lineup.

9. One or more servers comprising at least one processor and at least one memory storing a program of executable computer instructions;
wherein the at least one processor is configured with the at least one memory and the program of executable instructions to cause the one or more servers to perform actions comprising:
prior to a start of a multi-interval season for a sport, receive from each of a plurality of contestants a fantasy sports team comprising names of professional players of the sport associated with field positions;
prior to the start of at least an initial interval of the season, receive from respective ones of the contestants a lineup of their respective fantasy sports team in which each name of the respective lineup is associated with a field position;
prior to the start of each interval of the season:
allocate to a bracket league only those fantasy sports teams that are currently undefeated for the season;
allocate to a community league all fantasy sports teams that are not in the bracket league; and
select pairs of fantasy sports teams allocated to the bracket league to compete against one another during the respective interval;
following each of the intervals of the season:
assign to each fantasy sports team a score for the respective interval in dependence on performance of the professional players of the sport during the respective interval that match the names of the respective fantasy sports team lineup;
based on the respective fantasy sports team scores for the respective interval, determine for each pair of fantasy sports teams a winner and a loser; and
retain each winner in the bracket league for the next subsequent interval and move each loser to the community league for the next subsequent interval;
select the fantasy sports team that is determined to be the winner following a final interval of the season as a winner of the bracket league and awarding to the contestant associated with the winner of the bracket league a bracket league winner monetary prize; and
select one of the fantasy sports teams that did not compete in the bracket league during the final interval of the season as a winner of the community league and awarding to the contestant associated with the winner of the community league a community league winner monetary prize that is less than the bracket league winner monetary prize.

10. The one or more servers according to claim 9, wherein the multi-interval season consists of the initial interval, the final interval and multiple interim intervals between the initial and final intervals, and the actions further comprise:
following each of several but less than all consecutive ones of the interim intervals, award to each of the contestants associated with the respective fantasy sports teams that were determined for each pair of fantasy sports teams to be a winner for the respective interim interval a bracket league interim monetary prize that is less than the bracket league winner monetary prize.

11. The one or more servers according to claim 10, wherein an amount of the interim bracket league monetary prize for the respective several consecutive interim intervals increases progressively as the respective interim interval is nearer in time to the final interval.

12. The one or more servers according to claim 11, wherein:
the actions are performed over multiple brackets during the season;
there are a total of n intervals in the season and each bracket includes a maximum of 2ⁿ fantasy sports teams, where n is an integer at least five;
the winner of the bracket league and the winner of the community league are selected for each of the multiple brackets; and
the bracket league winner monetary prize and the community league monetary prize are awarded for each of the multiple brackets.

13. The one or more servers according to claim 11, wherein:
the sport is American football, each interval is a week, there are at least sixteen weeks in the season; and
the several but less than all consecutive ones of the interim intervals total at least eight consecutive weeks which immediately precede the final week of the season.

14. The one or more servers according to claim 11, the actions further comprising:
following selected ones of the several consecutive interim intervals, select at least one of the fantasy sports teams as a winner of the community league for the respective interim interval and award to the contestant associated with each of the selected at least one winner of the community league for the respective interim interval a community league interim monetary prize that is less than the community league winner monetary prize.

15. The one or more servers according to claim 9, wherein:
the lineup of each of the fantasy sports teams includes a first set of names associated with offensive field positions and a second set of names associated with defensive field positions; and
the scores for the respective intervals are assigned in dependence on performance of the professional players of the sport during the respective interval that match the first set of names and the second set of names of the respective fantasy sports team lineup.

16. One or more computer readable memories storing a program of computer instructions that when executed by one or more processors of one or more electronic devices causes the electronic devices to perform actions comprising:
prior to a start of a multi-interval season for a sport, receive from each of a plurality of contestants a fantasy sports team comprising names of professional players of the sport associated with field positions;
prior to the start of at least an initial interval of the season, receive from respective ones of the contestants a lineup of their respective fantasy sports team in which each name of the respective lineup is associated with a field position;
prior to the start of each interval of the season:
allocate to a bracket league only those fantasy sports teams that are currently undefeated for the season;
allocate to a community league all fantasy sports teams that are not in the bracket league; and
select pairs of fantasy sports teams allocated to the bracket league to compete against one another during the respective interval;
following each of the intervals of the season:
assign to each fantasy sports team a score for the respective interval in dependence on performance of the professional players of the sport during the respective interval that match the names of the respective fantasy sports team lineup;
based on the respective fantasy sports team scores for the respective interval, determine for each pair of fantasy sports teams a winner and a loser; and
retain each winner in the bracket league for the next subsequent interval and move each loser to the community league for the next subsequent interval;
select the fantasy sports team that is determined to be the winner following a final interval of the season as a winner of the bracket league and awarding to the contestant associated with the winner of the bracket league a bracket league winner monetary prize; and
select one of the fantasy sports teams that did not compete in the bracket league during the final interval of the season as a winner of the community league and awarding to the contestant associated with the winner of the community league a community league winner monetary prize that is less than the bracket league winner monetary prize.

17. The one or more computer readable memories according to claim 16, wherein the multi-interval season consists of the initial interval, the final interval and multiple interim intervals between the initial and final intervals, and the actions further comprise:
following each of several but less than all consecutive ones of the interim intervals, award to each of the contestants associated with the respective fantasy sports teams that were determined for each pair of fantasy sports teams to be a winner for the respective interim interval a bracket league interim monetary prize that is less than the bracket league winner monetary prize.

18. The one or more computer readable memories according to claim 17, wherein an amount of the interim bracket league monetary prize for the respective several consecutive interim intervals increases progressively as the respective interim interval is nearer in time to the final interval.

19. The one or more computer readable memories according to claim 18, wherein:
the actions are performed over multiple brackets during the season;
there are a total of n intervals in the season and each bracket includes a maximum of 2ⁿ fantasy sports teams, where n is an integer at least five;
the winner of the bracket league and the winner of the community league are selected for each of the multiple brackets; and
the bracket league winner monetary prize and the community league monetary prize are awarded for each of the multiple brackets.

20. The one or more computer readable memories according to claim 18, wherein:
the sport is American football, each interval is a week, there are at least sixteen weeks in the season; and
the several but less than all consecutive ones of the interim intervals total at least eight consecutive weeks which immediately precede the final week of the season.

21. The one or more computer readable memories according to claim 18, the actions further comprising:
following selected ones of the several consecutive interim intervals, select at least one of the fantasy sports teams as a winner of the community league for the respective interim interval and award to the contestant associated with each of the selected at least one winner of the community league for the respective interim interval a community league interim monetary prize that is less than the community league winner monetary prize.

22. The one or more computer readable memories according to claim 16, wherein:
the lineup of each of the fantasy sports teams includes a first set of names associated with offensive field positions and a second set of names associated with defensive field positions; and
the scores for the respective intervals are assigned in dependence on performance of the professional players of the sport during the respective interval that match the first set of names and the second set of names of the respective fantasy sports team lineup.
